(19) United States
(12) Patent Application Publication
(10) Pub. No.: US 2002/0126086 A1
(43) Pub. Date: Sep. 12, 2002

(54) Display apparatus

(75) Inventors: Yukihisa Takeuchi, Nishikamo-Gun (JP); Tsutomu Nanataki, Toyoake City (JP); Iwao Ohwada, Nagoya City (JP)

Correspondence Address: BURR & BROWN, PO BOX 7068, SYRACUSE, NY, 13261-7068, US

(73) Assignee: NGK Insulators, Ltd., Nagoya-City (JP)

(21) Appl. No.: 10/027,774

(22) Filed: Dec. 20, 2001

(30) Foreign Application Priority Data
Dec. 26, 2000 (JP) 2000-394,225

(51) Int. Cl. G09G 5/00

(52) U.S. Cl. 345/156; 345/87

(57) ABSTRACT

A display apparatus includes plural display units. Each display unit includes a light guide plate for transmitting light therethrough, and a display element provided opposite to one plate surface of the light guide plate. The display element includes a driving portion provided with actuator portions of a number corresponding to that of a number of pixels. The display element causes the light guide plate to display a video image according to an inputted image signal, by introducing light into the light guide plate and controlling displacement operations in contact and separation directions of the actuator portion with respect to the light guide plate according to properties of the image signal, and thereby controlling leakage light in a predetermined region of the light guide plate. The plural display units are joined and arranged so as to form a predetermined angle relative to each other.

### BACKGROUND OF THE INVENTION

1. Field of the Invention

The present invention relates to a display apparatus.

2. Description of Related Art

There has been proposed a display element that includes a light guide plate for transmitting light therethrough, and a driving portion arranged opposite to one plate surface of the light guide plate, wherein the driving portion is provided with actuator portions, the number of which corresponds to that of a number of pixels. The display element is operated so as to display a video image on the light guide plate according to an inputted image signal, by introducing light into the light guide plate and controlling displacement operations of the actuator portions in contact and separation directions with respect to the light guide plate according to properties of the image signal and controlling leakage light in a predetermined region of the light guide plate (see, U.S. Pat. No. 5,636,072 or JP-A-11-194723). The display element of such structure may be referred to as “display element related to the invention”, hereinafter.

The display element related to the invention differs from liquid crystal display or plasma display in that it does not basically require a seal structure. Thus, it is possible to realize a display element having a divided panel structure that is highly suitable for upsizing and reduction in thickness of the panel without particular difficulties. Also, since the display element is of direct viewing type, it is readily possible to achieve high contrast and satisfactory resistance to color fading even when irradiated by external light, besides that a more excellent view angle can be obtained in comparison with CRT.

### SUMMARY OF THE INVENTION

It is a primary object of the present invention to provide a novel display apparatus actively utilizing advantageous functional characteristics of the display element related to the present invention described above.

According to a first aspect of the present invention, there is provided a display apparatus which comprises plural display units, wherein each of the display units comprises a light guide plate for transmitting light therethrough, and a display element which is provided opposite to one plate surface of said light guide plate, said display element comprising a driving portion provided with actuator portions of a number corresponding to that of a number of pixels, said display element causing the light guide plate to display a video image according to an inputted image signal, by introducing light into the light guide plate and controlling displacement operations in contact and separation directions of the actuator portion with respect to the light guide plate according to properties of the image signal, and thereby controlling leakage light in a predetermined region of the light guide plate, and wherein the plural display units are joined and arranged so as to form a predetermined angle relative to each other. As used herein, the “joining” is to be understood as meaning that the display units are maintained in a predetermined angular position relative to each other, and is not necessarily limited to a physical contact between the display units.

In this case, it is preferred that the plural display units are joined so that the light guide plates of the display units, which are arranged adjacent to each other, form video image display surfaces that appear as if they are in one plane.

The joint angle of the display units may be set to an angle at which a joint portion of the display units protrudes away from a viewer. Alternatively, the joint angle of the display units may be set to an angle at which a joint portion of the display units protrudes toward a viewer.

In the display apparatus of the structure described above, a reflector is preferably arranged along a side of the light guide plate in a joint portion of the display units. In this case, a light source may be arranged between the side of the light guide plate and the reflector. Also, a reflector may be arranged along the side of the light guide plate, which is remote from the joint portion of the display units. Also in this case, a light source may be arranged between the side of the light guide plate and the reflector. Furthermore, a reflector may be arranged along the top and/or bottom of the light guide plate. Also in this case, a light source may be arranged between the top or bottom of the light guide plate and the reflector provided along the top or bottom.

In the display apparatus of the structure described above, a columnar transparent body may be arranged along the side of the light guide plate in a joint portion of the display units without being in contact with that side. In this case, a light absorption layer is preferably provided on the upper surface and the lower surface of the transparent body.

In the display apparatus of the structure described above, the light guide plate may be formed to have a wedge-like sectional shape with its thickness decreasing gradually toward the joint portion of the display units. In this case, a reflector having the required minimum area is advantageously provided on the side of the light guide plate in the joint portion of the display units. Then, a light source and a reflector are preferably arranged along the side of the light guide plate, which is remote from the joint portion of the display units, or along the top and/or bottom of the light guide plate.

According to a second aspect of the present invention, there is provided a display apparatus which comprises a display unit, wherein the display unit comprises a light guide plate for transmitting light therethrough, and a display element which is provided opposite to one plate surface of said light guide plate, said display element comprising a driving portion provided with actuator portions of a number corresponding to that of a number of pixels, said display element causing the light guide plate to display a video image according to an inputted image signal, by introducing light into the light guide plate and controlling displacement operations in contact and separation directions of the actuator portion with respect to the light guide plate according to properties of the image signal, and thereby controlling leakage light in a predetermined region of the light guide plate, and wherein the light guide plate is formed as a curved surface having a predetermined curvature.

In this case, it is preferred that a light source and/or a reflector are arranged along the side, top and/or bottom of the light guide plate.

It is preferred that plurality of the display apparatuses according to the present invention are combined with each other to form a structural body having a desired three-dimensional shape. In this case, it is possible to combine the light guide plates of the structural body so as to form a video image display plane on an inner surface of a planetarium.

According to a third aspect of the present invention, there is provided a display apparatus which comprises a display unit, wherein the display unit comprises a light guide plate for transmitting light therethrough, and a display element which is provided opposite to one plate surface of said light guide plate, said display element comprising a driving portion provided with actuator portions of a number corresponding to that of a number of pixels, said display element causing the light guide plate to display a video image according to an inputted image signal, by introducing light into the light guide plate and controlling displacement operations in contact and separation directions of the actuator portion with respect to the light guide plate according to properties of the image signal, and thereby controlling leakage light in a predetermined region of the light guide plate, and wherein the display unit is arranged to extend with a continuous band shape on a wall of a passage along which people traffic.

In this case, it is preferred that a sensor for detecting traffic of people is connected to the display apparatus, and the display apparatus is operated to display a video image on the light guide plate, when the sensor detects traffic of people.

According to a fourth aspect of the present invention, there is provided a display apparatus which comprises a display unit, wherein the display unit comprises a light guide plate for transmitting light therethrough, and a display element which is provided opposite to one plate surface of said light guide plate, said display element comprising a driving portion provided with actuator portions of a number corresponding to that of a number of pixels, said display element causing the light guide plate to display a video image according to an inputted image signal, by introducing light into the light guide plate and controlling displacement operations in contact and separation directions of the actuator portion with respect to the light guide plate according to properties of the image signal, and thereby controlling leakage light in a predetermined region of the light guide plate, and wherein the light guide plate forms a video image display surface in a cinema complex.

According to a fifth aspect of the present invention, there is provided a display apparatus which comprises plural display units, wherein each of the display unit comprises a light guide plate for transmitting light therethrough, and a display element which is provided opposite to one plate surface of said light guide plate, said display element comprising a driving portion provided with actuator portions of a number corresponding to that of a number of pixels, said display element causing the light guide plate to display a video image according to an inputted image signal, by introducing light into the light guide plate and controlling displacement operations in contact and separation directions of the actuator portion with respect to the light guide plate according to properties of the image signal, and thereby controlling leakage light in a predetermined region of the light guide plate, and wherein the display element and the light guide plate have desired shapes, respectively, and the display apparatus has a desired shape by arranging the display element in close contact with a back side of the light guide plate with a desired configuration.

According to a sixth aspect of the present invention, there is provided a display apparatus which comprises plural display units, wherein each of the display unit comprises a light guide plate for transmitting light therethrough, and a display element which is provided opposite to one plate surface of said light guide plate, said display element comprising a driving portion provided with actuator portions of a number corresponding to that of a number of pixels, said display element causing the light guide plate to display a video image according to an inputted image signal, by introducing light into the light guide plate and controlling displacement operations in contact and separation directions of the actuator portion with respect to the light guide plate according to properties of the image signal, and thereby controlling leakage light in a predetermined region of the light guide plate, and wherein the display element is arranged in close contact with a desired position on a back side of the light guide plate, and at least one of a blank region, a light emission body, a scattering body and a light absorbing body is arranged at other desired position or positions on the back side of the light guide plate.

According to a seventh aspect of the present invention, there is provided a display apparatus which comprises plural display units, wherein each of the display unit comprises a light guide plate for transmitting light therethrough, and a display element which is provided opposite to one plate surface of said light guide plate, said display element comprising a driving portion provided with actuator portions of a number corresponding to that of a number of pixels, said display element causing the light guide plate to display a video image according to an inputted image signal, by introducing light into the light guide plate and controlling displacement operations in contact and separation directions of the actuator portion with respect to the light guide plate according to properties of the image signal, and thereby controlling leakage light in a predetermined region of the light guide plate, and wherein said display elements include display elements having different color and/or different pixel area and/or different pixel pitch, and said display elements are arranged on a backside of the same light guide plate.

According to an eighth aspect of the present invention, there is provided a display apparatus which comprises plural display units, wherein each of the display unit comprises a light guide plate for transmitting light therethrough, and a display element which is provided opposite to one plate surface of said light guide plate, said display element comprising a driving portion provided with actuator portions of a number corresponding to that of a number of pixels, said display element causing the light guide plate to display a video image according to an inputted image signal, by introducing light into the light guide plate and controlling displacement operations in contact and separation directions of the actuator portion with respect to the light guide plate according to properties of the image signal, and thereby controlling leakage light in a predetermined region of the light guide plate, and wherein said display elements are arranged on backsides of the light guide plates, and the light guide plates are so arranged as to display portions of a video image from the same image signal source, respectively.

### BRIEF DESCRIPTION OF THE DRAWINGS

The present invention will be described below in further detail with reference to preferred embodiments that are illustrated in the accompanying drawings.

FIG. 1 is a sectional view showing a basic structure of a display element that can be suitably used in the display apparatus according to the present invention.

FIG. 2 is a schematic view diagrammatically showing a display apparatus according to a first embodiment of the present invention.

FIG. 3 is a schematic view diagrammatically showing a display apparatus 40 according to a second embodiment of the present invention.

FIGS. 4A and 4B are perspective view and plan view diagrammatically showing a display apparatus according to a third embodiment of the present invention, respectively.

FIGS. 5A and 5B are perspective view and plan view diagrammatically showing a display apparatus according to a fourth embodiment of the present invention, respectively.

FIGS. 6A and 6B are plan view and perspective view diagrammatically showing a display apparatus according to a fifth embodiment of the present invention, respectively.

FIGS. 7A and 7B are plan view and perspective view diagrammatically showing a display apparatus according to a sixth embodiment of the present invention, respectively.

FIGS. 8A to 8D are diagrammatic views illustrating examples of the sectional shape of a columnar transparent body in the sixth embodiment, respectively.

FIGS. 9A and 9B are plan view and perspective view diagrammatically showing a display apparatus according to a sixth embodiment of the present invention, respectively.

FIG. 10 is a diagrammatic view showing a modified example of the seventh embodiment.

FIGS. 11A and 11B are plan view and perspective view diagrammatically showing a display apparatus according to an eighth embodiment of the present invention, respectively.

FIGS. 12A and 12B are plan view and perspective view diagrammatically showing a display apparatus according to a ninth embodiment of the present invention, respectively.

FIG. 13 is a diagrammatic view showing a typical arrangement of the display elements with respect to a light guide plate.

FIG. 14 is a diagrammatic view illustrating various forms of display elements.

FIG. 15 is a diagrammatic view illustrating another form of a light guide plate.

FIG. 16 is a diagrammatic view showing an embodiment in which display elements are not arranged on the whole back surface of a light guide plate by locally eliminating a display element.

FIG. 17 is a sectional view showing a blank portion provided in a light guide plate.

FIGS. 18A and 18B are sectional view and front view showing one example of light emission pixel, etc., provided on the backside of a light guide plate, respectively.

FIGS. 19A and 19B are sectional view and rear view showing another example of a light emission pixel, etc., provided on the backside of a light guide plate, respectively.

FIGS. 20A and 20B are sectional views showing one example of a light emission pixel, etc., shown in FIG. 19, respectively.

FIGS. 21A and 21B are sectional views showing a concrete example of a blank region 132 shown in FIGS. 16 and 17, respectively.

FIG. 22 is a diagrammatic view showing an example in which display elements with different specifications are provided for a light guide plate.

### DETAILED DESCRIPTION OF PREFERRED EMBODIMENTS

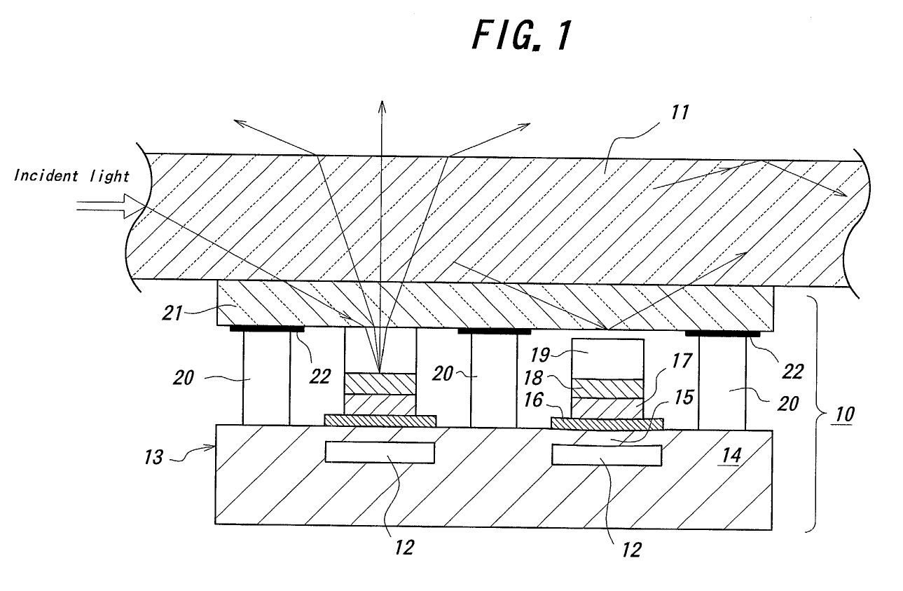

Referring now to FIG. 1, there is shown a display element that can be suitably used in the display apparatus according to the present invention. The display element is designated as a whole by reference numeral 10, and includes a light guide plate 11 for introducing light, for example, from a side surface and a driving portion 13 which is arranged opposite to one plate surface of the light guide plate 11 and provided with actuator portions 12 of the number corresponding to that of a number of pixels. Then, by controlling displacement operations of the actuator portions 12 in contact and separation directions with respect to the light guide plate 11 according to properties of an image signal inputted to the apparatus and thereby controlling leakage light in a predetermined region of the light guide plate 11, a video image according to the image signal is displayed on the light guide plate 11.

As disclosed in U.S. Pat. No. 5,636,072 or JP-A-11-194723 cited above, the actuator portion 12 has a structure in which a thin-wall portion 15 is formed in a substrate 14 made of ceramics such as zirconia and a piezoelectric/electrostrictive layer or anti-ferroelectic substance layer 16, a white scattering body layer 17, a color light emission body layer 18 and a contact layer 19 are sequentially formed on the thin-wall portion 15. Also, a light guide plate 21 is supported by the substrate 14 through plural posts 20, and is arranged in close contact with the light guide plate 11. Incidentally, a reflector or light absorption layer 22 is arranged between the posts 20 and the light guide plate 21.

The actuator portion 12 shown on the right side of FIG. 1 corresponds to the case of non-light emission of the display element 10, wherein the piezoelectric/electrostrictive layer or anti-ferroelectric substance layer 16 and the thin-wall portion 15 are retracted downwards and the contact layer 19 is separated from the light guide plate 21. Therefore, light introduced from one side of the light guide plate 11 advances toward the other side while repeating total reflection between an inner surface on the front side of the light guide plate 11 and an inner surface on the back side of the light guide plate 21 arranged in close contact with the light guide plate 11. On the other hand, the actuator portion 12 shown on the left side of FIG. 1 corresponds to the case of light emission of the display element 10, wherein the piezoelectric/electrostrictive layer or anti-ferroelectric substance layer 16 and the thin-wall portion 15 protrude upwards and the contact layer 19 is in contact with the light guide plate 21. Therefore, light, which is introduced from one side of the light guide plate 11 and totally reflected between an inner surface of the light guide plate 11 and an inner surface of the light guide plate 21, is transmitted to a surface of the color light emission body layer 18 through the contact layer 19, and emitted from the front side of the light guide plate 11 as scattered light of color corresponding to the color of the color light emission body layer 18.

The light introduced into the light guide plate 11 has a wavelength that may be within any one of ultraviolet range, visible range and infrared range. As a light source, there may be used an incandescent lamp, a deuterium discharge lamp, a fluorescent lamp, a mercury lamp, a metal halide lamp, a halogen lamp, a xenon lamp, a tritium lamp, a light emitting diode, a laser, a plasma light source, a hot-cathode tube (including one in which filament-shaped hot cathode is replaced by carbon nanotube-field emitter), a cold cathode tube, a black light source, an infrared light radiation source, a neon tube, etc.

The light guide plate 11 has a light refractive index so that light introduced into the inside is totally reflected without penetrating the outside of the plate guide light 11 on the front and back sides, and requires that transmittance in the wavelength range of the light introduced into, and guided by the light guide plate 11 is uniform and high. As long as such properties are satisfied, the material is not limited particularly, and specifically, for example, glass, quartz, translucent plastics such as acrylic or polycarbonate plastics, translucent ceramics, or a multi-layer structure body of materials having a different refractive index, or things in which a coating layer is provided on the surface, etc., may be listed in a general sense.

Since the basic structure and functions of the display element related to the present invention described above are disclosed in U.S. Pat. No. 5,636,072 or JP-A-11-194723 cited above, detailed description is omitted for the sake of convenience. It is to be noted, however, that disclosure of these patent documents is herein incorporated by reference.

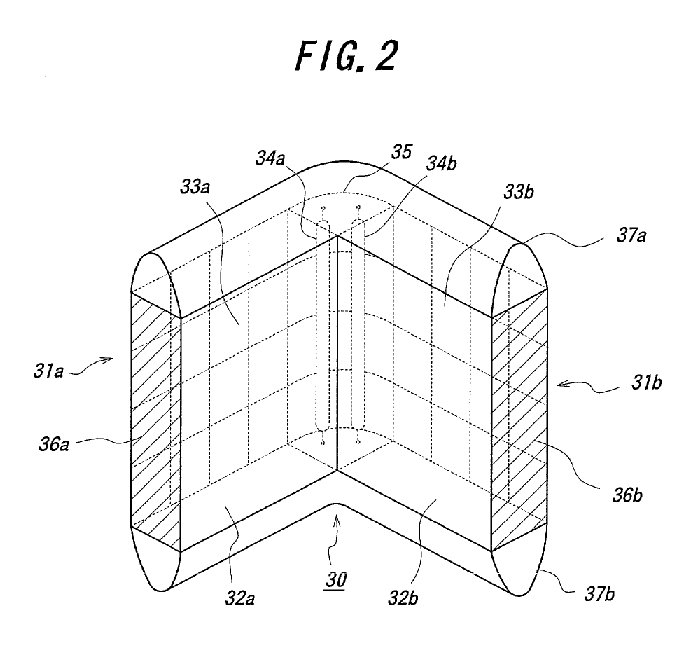

FIG. 2 is a schematic view diagrammatically showing a display apparatus 30 according to a first embodiment of the present invention. The display apparatus 30 is constructed by joining and placing a pair of right and left display units 31a, 31b so as to form a predetermined angle relative to each other. The display apparatus 30 is featured by such an arrangement that a video image can be displayed also in a region where adjacent light guide plates 32a, 32b of the respective display units 31a, 31b are joined to each other at a predetermined angle. Also, it is possible to join the adjacent display units such that the light guide plates of the display units form video image display surfaces that appear as if they are in one plane. Such display of the video image can be implemented relatively easily, by using suitable coordinate transformation software. In the present embodiment, the joint angle of the display units 31a, 31b is set to an angle at which the joint portion of the display units 31a, 31b protrudes in a direction away from tie viewer. Multiple display elements 33a, 33b each exhibiting a tile shape are arranged on the backside of the light guide plates 32a, 32b mutually in close contacted with each other. Incidentally, each display element 33a, 33b has the same structure as that described with reference to FIG. 1.

Within a space between the mutual sides of the light guide plates 32a, 32b at the joint portion of the display units 31a, 31b, there are arranged light sources 34a, 34b extending along the sides of the light guide plates 32a, 32b and a trough-shaped reflector 35 for shielding the back side of the light sources 34a, 34b. Further, reflectors 36a, 36b are arranged on the other sides of the light guide plates 32a, 32b remote from the joint portion of the display units 31a, 31b, and trough-shaped reflectors 37a, 37b having a bend shape according to the joint angle of the display units 31a, 31b are arranged on the top and the bottom, respectively. Incidentally, the reflectors 36a, 36b may be formed to have a trough shape. Instead of placing the light sources 34a, 34b between the mutual sides of the light guide plates 32a, 32b at the joint portion of the display units 31a, 31b, the light sources may be arranged inside the trough-shaped reflectors which, in turn, are arranged on the other sides, top and/or bottom of the light guide plates 32a, 32b.

The trough-shaped reflector used in the embodiment described above can be constructed by molding, for example, a metal plate into any required shape. It is preferred, though, the trough-shaped reflector has a specific shape in which air layer is included in the inside of the reflector, i.e., a shape that assures total reflection of incident light from the light source in order to prevent scattering.

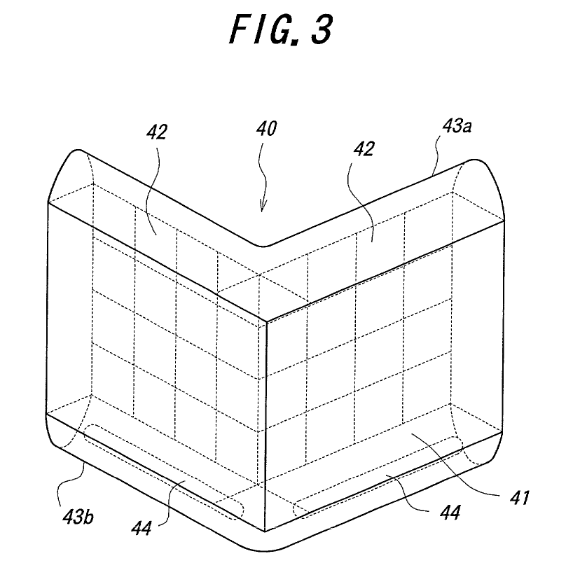

FIG. 3 is a schematic view diagrammatically showing a display apparatus 40 according to a second embodiment of the present invention. This display apparatus 40 is similar to the first embodiment described above, except that a light guide plate 41 is of L-shape and arranged such that the center of the light guide plate 41 protrudes toward a viewer. The second embodiment is essentially same as the first embodiment in that multiple display elements 42 having a tile shape are arranged on the backside of the light guide plate 41 in close contact with each other. In the present embodiment, a reflector (not shown) is arranged on the side of the light guide plate 41 and trough-shaped reflectors 43a, 43b having a bend shape according to the shape of the light guide plate 41 are arranged on the top and bottom of the light guide plate 41, respectively. Further, light sources 44 are arranged inside the reflector 43b that is provided on the bottom of the light guide plate 41. Although not shown in the drawing, light sources can also be arranged inside the reflector 43a that is provided on the top of the light guide plate 41.

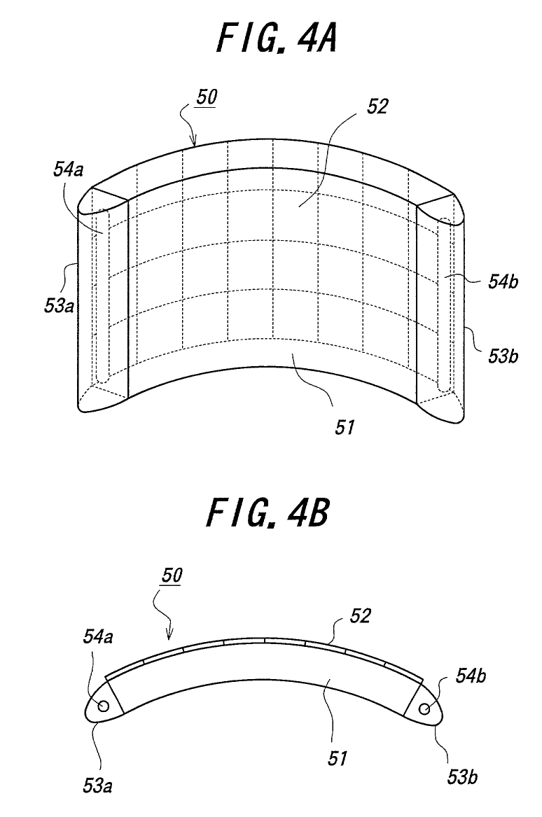

FIGS. 4A and 4B are schematic views diagrammatically showing a display apparatus 50 according to a third embodiment of the present invention. In this embodiment, the light guide plate 51 of the display apparatus 50 is formed to have a curved surface with a predetermined curvature, with the center of the light guide plate 51 protruding in a direction away from the viewer. Multiple display elements 52 having a tile shape are arranged on the backside of the light guide plate 51, in close contact with each other. Also, trough-shaped reflectors 53a, 53b are arranged on the sides of the light guide plate 51 and light sources 54a, 54b are arranged inside the reflectors 53a, 53b. The reflectors 53a, 53b and the light sources 54a, 54b may be arranged on the top and/or bottom of the light guide plate 51. Incidentally, in the embodiment shown in FIGS. 4A and 4B, the display elements 52 are arranged over the entire area of the backside of the light guide plate 51. However, the display elements 52 may be arranged only locally in the backside of the light guide plate 51.

When the light guide plate is formed to have a curved surface, as in the present embodiment, it is important to properly control the angle of incidence by such means as adjusting the curvature of the light guide plate and/or location of the light source, etc., to thereby prevent leakage of the incident light from the light source. To this end, for example, it is desirable to use a light source for launching light as substantially parallel light without scattering the light. As such a light source, for example, it is preferred to use a metal halide light source (MME-250 type) manufactured and sold by Moritex Corp., together with a light guide (MKP180-1500S type) also manufactured and sold by Moritex Corp. The incident angle of the light with respect to the light guide plate can also be suitably controlled by arranging a biconvex lens or flat/convex lens having a flat surface and a convex 10 surface on opposite sides, between the light source and the opposite surface of the light guide plate.

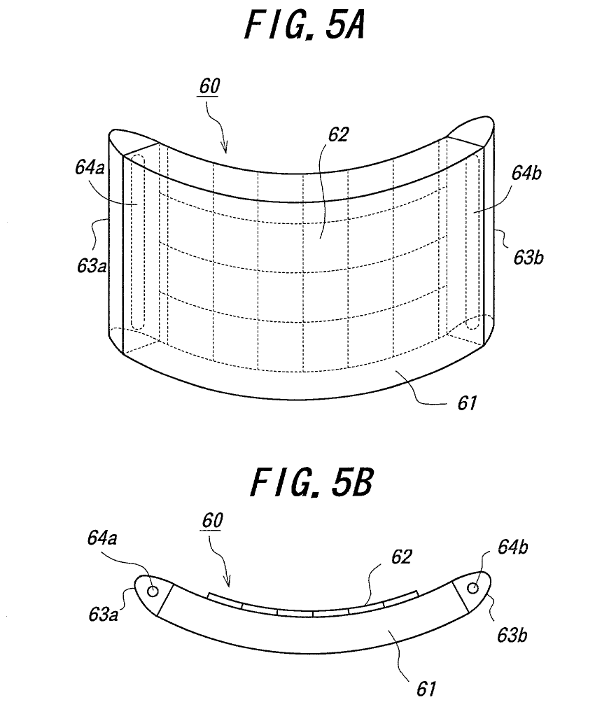

FIGS. 5A and 5B are schematic views diagrammatically showing a display apparatus 60 according to a fourth embodiment of the present invention. In this embodiment, although the light guide plate 61 of the display apparatus 60 is formed to have a curved surface with a predetermined curvature as in the third embodiment described above, the center of the light guide plate 61 protrudes in a direction toward a viewer. In other respect, the fourth embodiment is has basically the same structure as the third embodiment. That is, multiple display elements 62 having a tile shape are arranged on the backside of the light guide plate 61, in close contact with each other. Also, trough-shaped reflectors 63a, 63b are arranged on the sides of the light guide plate 61 and light sources 64a, 64b are arranged inside the reflectors 63a, 63b. The reflectors 63a, 63b and the light sources 64a, 64b may also be arranged on the top and/or bottom of the light guide plate 61. Here also, it is not an essential condition that the tile-shaped display elements 62 be arranged over the entire area of the backside of the light guide plate 61 is not an essential. Thus, for example, the display apparatus 60 may be formed to have a configuration in which the display elements 62 are not arranged in the back area of the light guide plate 61 adjacent to the trough-shaped reflectors 63a, 63b, as shown in FIG. 5B.

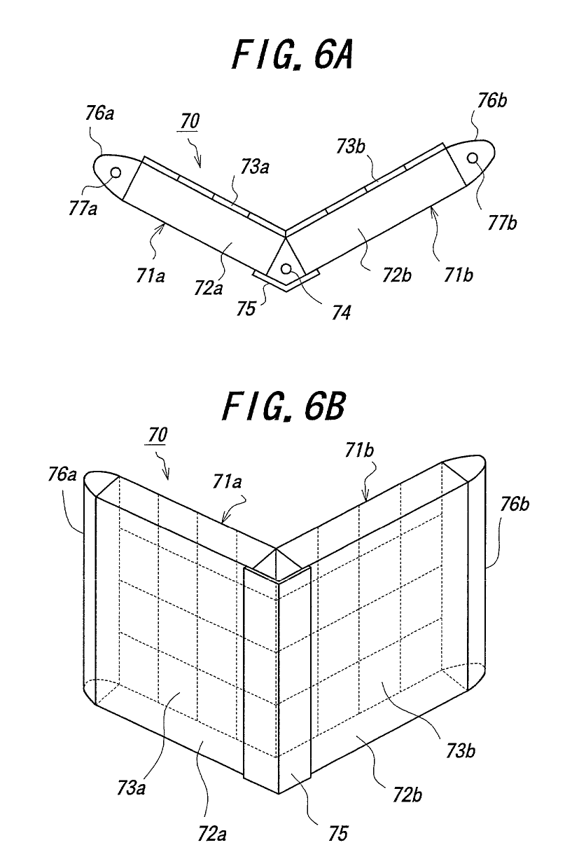

FIGS. 6A and 6B are schematic views diagrammatically showing a display apparatus 70 according to a fifth embodiment of the present invention. This display apparatus 70 is constructed by joining and placing a pair of right and left display units 71a, 71b so as to form a predetermined angle relative to each other, with a joint angle of the display units 71a, 71b being set to an angle at which the joint portion of the display units 71a, 71b protrudes toward a viewer. Multiple display elements 73a, 73b having a tile shape are arranged on the backsides of light guide plates 72a, 72b in close contact with each other. A light source 74 extending along the sides of the light guide plates 72a, 72b and a roof-shaped reflector 75 for shielding the front side of the light source 74 are arranged in a space between the opposite sides of the light guide plates 72a, 72b at the joint portion of the display units 71a, 71b. Also, trough-shaped reflectors 76a, 76b are arranged on those sides of the light guide plates 72a, 72b, that are located remote from the joint portion of the display units 71a, 71b, and light sources 77a, 77b are arranged inside these reflectors 76a, 76b. Incidentally, the light sources and the reflectors may be arranged on the top and/or bottom of the light guide plates 72a, 72b.

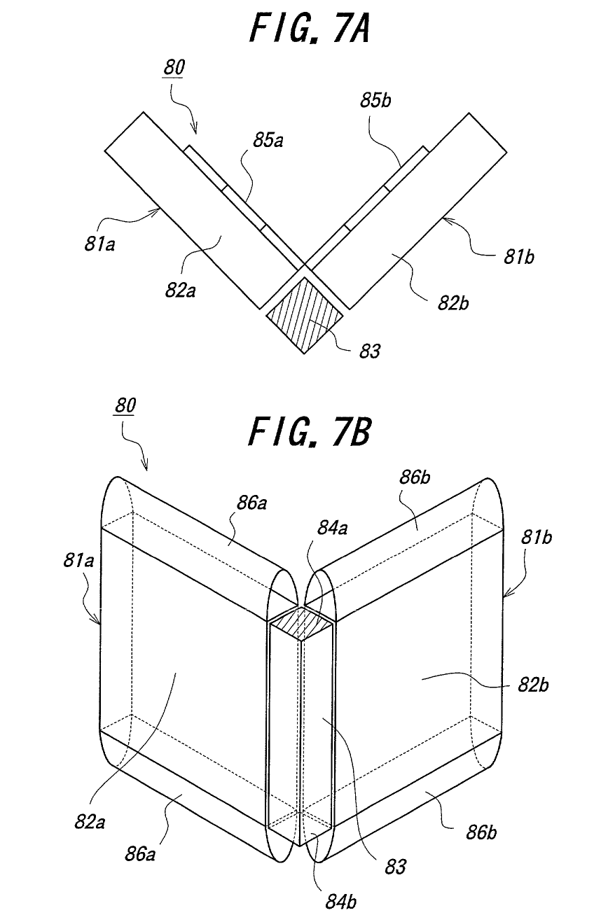

FIGS. 7A and 7B are schematic views diagrammatically showing a display apparatus 80 according to a sixth embodiment of the present invention. This display apparatus 80 is similar to the fifth embodiment described above, except that a columnar transparent body 83 having a predetermined sectional shape is arranged in the space formed by light guide plates 82a, 82b at a joint portion of a pair of display units 81a, 81b that are joined and arranged so as to form a predetermined angle relative to each other. It is assumed that the transparent body 83 are maintained in a non-contact state with respect to the sides of the light guide plates 82a, 82b. Also, light absorption layers 84a, 84b are provided on the top and bottom of the transparent body 83. Multiple display elements 85a, 85b having a tile shape are arranged on the backsides of light guide plates 82a, 82b, in close contact with each other. Further, trough-shaped reflectors 86a, 86b are arranged on the top and bottom of the light guide plates 82a, 82b, and light sources are arranged inside these reflectors 86a, 86b. Incidentally, as in the embodiment FIG. 5B, the display apparatus 80 according to the present embodiment is formed into a configuration in which the display elements 85a, 85b are not arranged on those areas in the backside, which are adjacent to the sides of the light guide plates 82a, 82b.

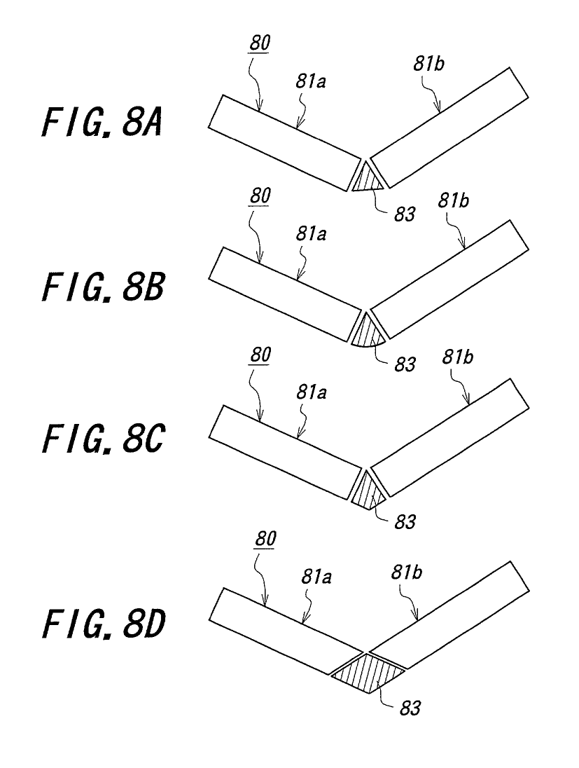

FIGS. 8A to 8D illustrate a sectional shape of the columnar transparent body 83 in the sixth embodiment described above. The sectional shape of the transparent body 83 is triangle in FIG. 8A, sector in FIG. 8B, quadrilateral in FIG. 8C that is formed by joining a pair of mutually symmetric scalene triangles at their bases, and rhombic in FIG. 8D.

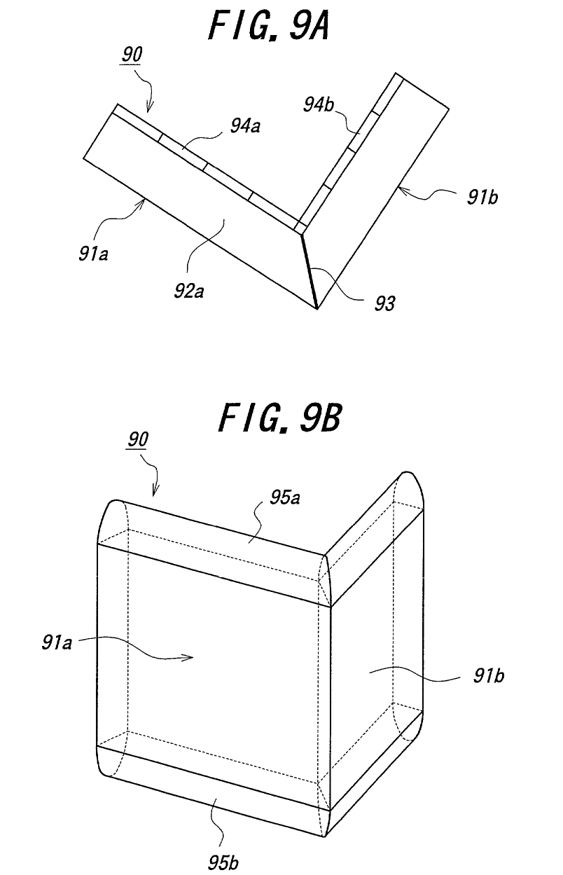

FIGS. 9A and 9B are schematic views diagrammatically showing a display apparatus 90 according to a seventh embodiment of the present invention. This display apparatus 90 is similar to the fifth and sixth embodiments described above, in that a pair of display units 91a, 91b are joined and arranged so as to form a predetermined angle relative to each other, though the sides of light guide plates 92a, 92b at the joint portion are in contact with each other through a metal layer 93 that functions as a reflector layer and also as a shielding layer. Multiple display elements 94a, 94b having a tile shape are arranged on the backsides of the light guide plates 92a, 92b, in close contact with each other. Further, trough-shaped reflectors 95a, 95b are arranged on the top and bottom of the light guide plates 92a, 92b, and light sources are arranged inside these reflectors 95a, 95b.

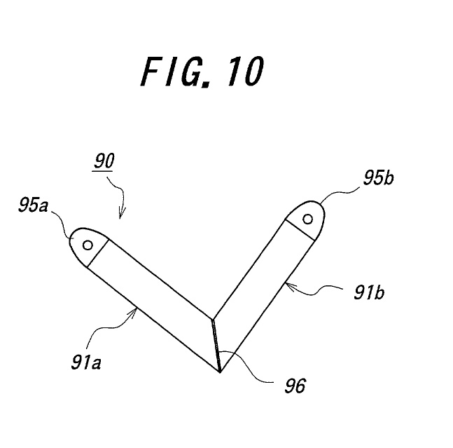

FIG. 10 shows a modified example of the seventh embodiment described above. In the present example, instead of the reflector layer 93, a light absorption layer 96 is provided on the sides of the light guide plates 92a, 92b at the joint portion of the display units 91a, 91b. Incidentally, in the present example, the light sources and the trough-shaped reflectors 95a, 95b are arranged on those sides of the light guide plates 92a, 92b, which are remote from the joint portion of the display units 91a, 91b.

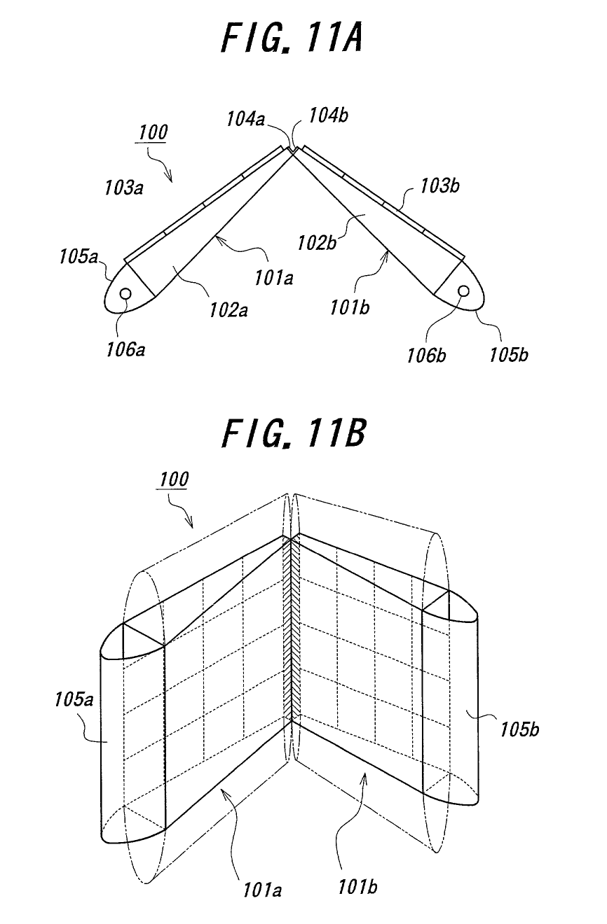

FIGS. 11A and 11B are schematic views diagrammatically showing a display apparatus 100 according to an eighth embodiment of the present invention. In this display apparatus 100, as in the first embodiment described above, the joint portion of a pair of display units 101a, 101b protrudes in a direction away from the viewer, though the light guide plates 102a, 102b of the display units 101a, 101b are of a wedge-like shape in cross-section, with the thickness decreasing gradually toward the joint portion of the display units 101a, 101b. Multiple display elements 103a, 103b having a tile shape are arranged on the backsides of the light guide plates 102a, 102b, in close contact with each other. Reflectors or light absorbers 104a, 104b are arranged on the sides of the light guide plates 102a, 102b at the joint portion of the display units 101a, 101b. The reflectors or light absorbers 104a, 104b are advantageous in they may have a small area. Further, trough-shaped reflectors 105a, 105b are arranged on those sides of the light guide plates 102a, 102b, that are remote from the joint portion of the display units 101a, 101b, and light sources 106a, 106b are arranged inside these reflectors 105a, 105b. Incidentally, the light sources and the trough-shaped reflectors may be arranged on the top and/or bottom of the light guide plates 102a, 102b as shown by imaginary lines in FIG. 11B.

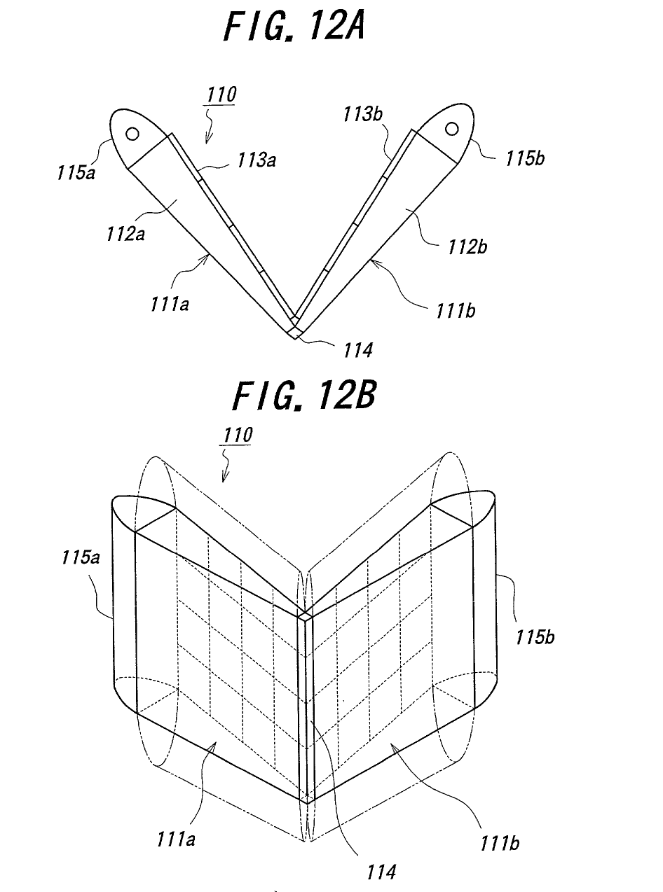

FIGS. 12A and 12B are schematic views diagrammatically showing a display apparatus 110 according to a ninth embodiment of the present invention. This display apparatus 110 is similar to the eighth embodiment described above, though the joint portion of a pair of display units 111a, 111b protrudes toward the viewer. Thus, in the present embodiment also, the light guide plates 112a, 112b of the display units 111a, 111b have a wedge-like shape in cross-section, with the thickness decreasing gradually toward the joint portion of the display units 111a, 111b. Multiple display elements 113a, 113b having a tile shape are arranged on the backsides of the light guide plates 112a, 112b, in close contact with each other. A reflector or light absorber 114 is arranged on the sides of the light guide plates 112a, 112b at the joint portion side of the display units 111a, 111b. This reflector or light absorber 114 is advantageous in that it may have a small area. Further, trough-shaped reflectors 115a, 115b are arranged on those sides of the light guide plates 112a, 112b, which are remote from the joint portion of the display units 111a, 111b, and light sources are arranged inside these reflectors 115a, 115b. Incidentally, the light sources and the trough-shaped reflectors may be arranged on the top and/or bottom of the light guide plates 112a, 112b.

Next, explanation will be made of certain examples in terms of arranging the display elements with respect to a light guide plate of a display apparatus according to the present invention.

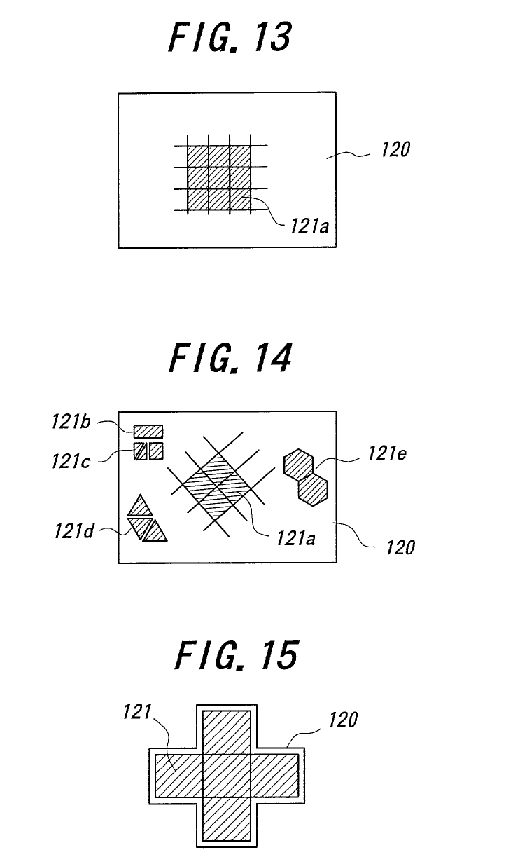

First, FIG. 13 shows a general example in which a display element 121a having an approximately square shape is arranged in a grid-like regular manner with respect to a light guide plate 120. However, the arranging method of the display elements with respect to the light guide plate 120 is not limited to only such an example. Thus, for example, the display elements 121a having an approximately square shape may be inclined and arranged as shown at the center of FIG. 14. Further, the display elements 121b, 121c shown on the upper left region of FIG. 14 are formed in a rectangle or triangle, the display element 121d shown in the lower left region are formed in a regular triangle, and the display element 121e shown in the right region is formed in a regular hexagon, respectively. In any case, basically, multiple display elements having the same shape are arranged on the backside of the light guide plate 120 in close contact with each other.

Also, the shape of the light guide plate 120 is not limited to square or rectangle. For example, the embodiment shown in FIG. 15 has a configuration in which the light guide plate 120 is formed in a cross-shape, and five display elements 121 having a substantially square shape are arranged on the backside of the light guide plate 120 forming a similar a cross-shape. Such an embodiment minimizes the cost of the entire apparatus by arranging the necessary minimum number of display elements at the required region only. Incidentally, with regard to the shape of the light guide plate or arrangement form of the display elements, it is of course that various modified forms other than the above may be made.

It has been described above that arrangement of tile-shaped display elements in the entire back surface of the light guide plate is not an essential condition. Thus, there will be described below certain configuration examples wherein the display element is locally eliminated for an intended purpose.

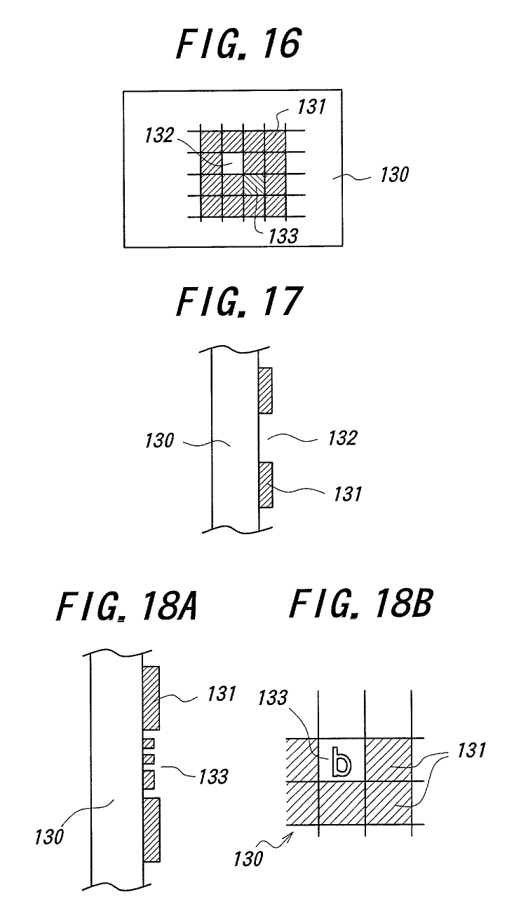

The embodiment shown in FIG. 16 has a basic configuration in which multiple display elements 131 having a substantially square shape are arranged on the backside of a light guide plate 130, though a blank region 132 free from the display element 131 is provided at the center of the light guide plate 130, and a light emission body, white scattering body or light absorber 133 and the like is arranged instead of some of the display elements 131.

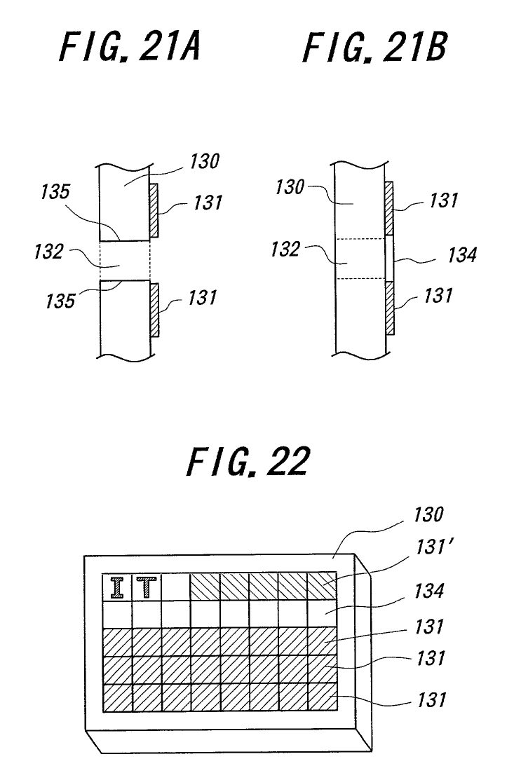

In this instance, the blank region 132 may be formed of a hollow region, as shown in FIG. 21A. It is preferable to provide a reflector 135 inside the hollow blank portion 132. Such a hollow blank portion 132 may be used as a window frame, or may be used to arrange input devices or suitable artistic object therein. Also, when the blank portion is a solid portion, as shown in FIG. 21B, it is possible to easily and positively improve the positioning accuracy of the display element 131 by arranging a light guide support 134 similar to the above on the backside of the light guide plate 130.

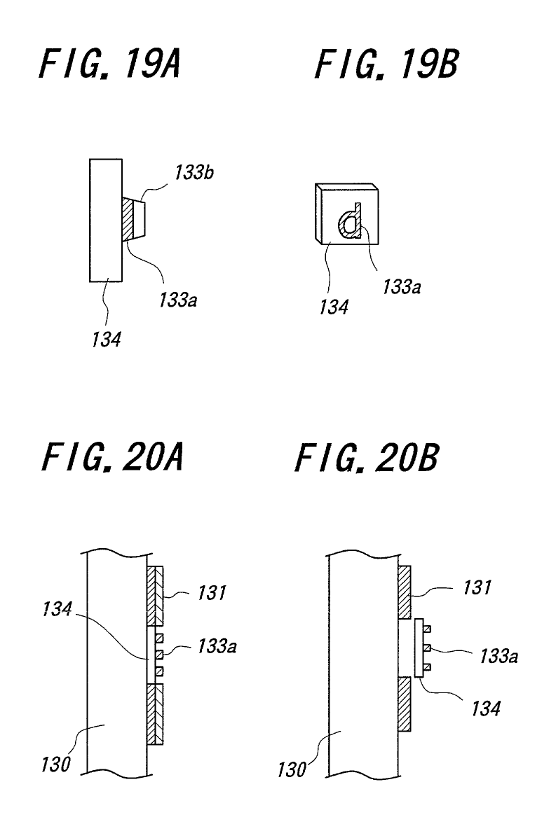

FIG. 17 is a sectional view showing the blank region 132 in the embodiment of FIG. 16. Also, FIG. 18A shows an example in which the light emission body, white scattering body or light absorber 133 and the like is arranged directly on the backside of the light guide plate 130. In this case, the light emission body, white scattering body or light absorber 133 and the like may be used to represent a mark, for example, a character “b”. The mark, which is represented by the light emission body, white scattering body or light absorber 133 and the like, may be emitted, scattered or absorbed by light introduced into the light guide plate 130, so as to be visible from outside, as shown in FIG. 18B. The character “b” in this case differs from a video image displayed by the display apparatus, and is used as a static information or immovable message. The light emission body, white scattering body or light absorber 133 and the like may be arranged on the backside of the light guide support 134 made of the same material as the light guide plate 21 of the display element 10 shown in FIG. 1, with the light guide support 134 being arranged on the backside of the light guide plate 130. FIGS. 19A and 19B show an example in which a light emission body 133a and a white scattering body 134b are arranged on the backside of a light guide support 134, and a character “b” is represented by the light emission body 133a. When such light guide support 134 is arranged directly on the backside of a light guide plate 130, as shown in FIG. 20A, the thickness of the light guide support 134 is preferably set to the same thickness as the light guide plate (the light guide plate 21 in FIG. 1) in the display element. Also, the light guide support 134 carrying the light emission body 133a on its backside may be arranged spaced from the light guide plate 130 and in the back side, as shown in FIG. 20B. In this case, the character “b” represented by the light emission body 133a is emitted by light incident from the front surface of the light guide plate 130 so as to be visible from outside, as in the case of FIG. 18B.

As a modified example of the configuration shown in FIG. 16, a general-purpose input device such as a button operated by a user can also be arranged in the blank region provided in the light guide plate of a display apparatus, so that the apparatus according to the present invention may be used as an interactive display apparatus.

In the display apparatus according to the present invention, it is not necessary that the display elements arranged on the backside of the light guide plate have the same specifications. Thus, for example, a part of the display apparatus may be formed into a color image display region with high definition and another part may be formed into a black-and-white or monochromatic high-brightness message display region. Also, the size of dots in a part of the display apparatus may be varied relative to the size of dots in the remaining part.

For example, as shown in FIG. 22, it is possible to provide a light guide plate 130 with display elements 131 corresponding to a color image display region, a light absorber 133 and its support 134 corresponding to static information or immovable message, a support region 134 with increased size of dot as compared with the color image display region to achieve higher brightness and reduction in electric power consumption, and a region 131′ for achieving even higher brightness by using white or monochromatic display.

The display apparatus according to the present invention explained above with reference to various embodiments differs from a liquid crystal display or a plasma display in that a seal structure is not required. Thus, it is possible to realize a display element having a divided panel structure that is highly suitable for upsizing and reduction in thickness of the panel without particular difficulties. Also, since the display element is of direct viewing type, it is readily possible to achieve high contrast and satisfactory resistance to color fading even when irradiated by external light, besides that a more excellent view angle can be obtained in comparison with CRT. By utilizing such advantages, the display apparatus according to the present invention can be suitable used for the following applications.

First, the embodiments shown in FIG. 2, FIGS. 4A and 4B and FIGS. 11A and 11B may be used preferably as a corner type television set that is arranged in the corner of a living room and so on. Further, the embodiments shown in FIG. 3, FIGS. 5A and 5B, FIGS. 6A and 6B, FIGS. 7A and 7B, FIGS. 9A and 9B and FIGS. 11A and 11B may be arranged adjacent to a protrusion of a column, beam, etc. inside a room, thereby improving use efficiency of space which otherwise may become useless. In addition, by combining the embodiments shown in FIG. 2, FIGS. 4A and 4B and FIGS. 11A and 11B with the embodiments shown in FIG. 3, FIGS. 5A and 5B, FIGS. 6A and 6B, FIGS. 7A and 7B, FIGS. 9A and 9B and FIGS. 12A and 12B, it is readily possible to implement a display apparatus with a stair shape or a folding screen shape.

The display apparatus according to the present invention can relatively easily cope with upsizing and thickness reduction of a panel and can be implemented even, for example, in a large display plane of 300 inches. Also, since the display element is of direct viewing type, it is readily possible to achieve high contrast and satisfactory resistance to color fading even when irradiated by external light, besides that a more excellent view angle can be obtained in comparison with CRT. Thus, the display apparatus according to the present invention can also be used preferably as a video image display plane in a cinema complex. In this case, because of the direct viewing type, the need for space for installation of, for example, a projector etc. can be eliminated and used as a space for audience.

Also, the display apparatus according to the present invention can easily adopt a divided panel structure so that it can be arranged as a band-like display with an extreme aspect ratio, for example, extending along a wall of passage which people traffic. In this case, it is preferred that a sensor for detecting the traffic of people is connected to the display apparatus such that vide image is displayed on a light guide plate when the traffic of people is detected by the sensor.

Further, since the display apparatus according to the present invention is may be formed as a curved surface display having any desired three-dimensional shape. Thus, for example, it is readily possible to implement a cylindrical or pseudo-cylindrical display apparatus, or a spherical or pseudo-spherical display apparatus.

Still another embodiment will be explained below, in which the display apparatus according to the present invention is applied to a planetarium.

In order to represent constellations or stars such as a fixed star, a planet or a satellite (hereinafter collectively called “star”), conventionally, a projector manufactured optically accurately is precisely installed at a predetermined place without significant error, so that a light spot is projected onto a large dome-shaped screen manufactured accurately, by mechanically operating the projector. It naturally takes considerable time and effort to accurately manufacture such a large dome-shaped screen and the cost increased accordingly, besides that a certain degree of uneven error or distortion had to be accepted. Also, since it is necessary to accurately manufacture the optical projector and represent revolution of star mainly by rotation of the projector, the structure becomes highly complicated and the cost increases accordingly, besides that it takes time and effort for repair, maintenance and so on. Further, since the star is a light spot projected on the dome-shaped screen, for example, disturbance light associated with opening and closing of the doorway was reflected by the screen and distinction was difficult. As a result of that, the coming and leaving of audience during the showing cycle had to be limited.

When the display apparatus according to the present invention is applied to a planetarium, since the star is represented by a group of pixels on a display, the accuracy of the apparatus is not required, and the space for installation of the projector conventionally required at the center of the planetarium becomes unnecessary, so that the seating capacity of the facilities can be increased accordingly. Also, since the revolution of star is represented by a group of pixels on the display, video software can be relatively easily implemented with which any stars (fixed star, planet or shooting star) can be represented simply. Further, since the equipment costs of the dome-shaped screen manufactured accurately or the projector manufactured optically accurately, etc. are not required, the size of the seating capacity of the planetarium can be designed relatively freely.

By providing the outermost surface of a display with a light absorption layer or light reflective layer that is reflective in a constant direction, and also optionally providing the light guide plate with a light refractive layer of air layer etc., the disturbance light associated with opening and closing of the doorway (corresponding to a blank region of FIG. 16) can be absorbed or reflected in the constant direction by the outermost surface of the display. As a result, the disturbance light can clearly be distinguished from the star that is represented by a group of pixels on the display and the limitation for the comings and leaving of audience during the showing cycle can be eliminated. Therefore, for example, it is possible to propose new service forms of complex planetarium/restaurant equipped with a table with stand light, wherein the center inside seats of the planetarium serves to display a constellation show utilizing earphone set, and the outer periphery portion is used for enjoyment of dinner while viewing a starry sky, etc.

Incidentally, even when a video display surface of the planetarium is constructed by a plane display arranged in a polyhedron shape, for example, a regular icosahedron shape, the star is represented by a group of pixels, so that, for example, by increasing the area of a group of pixels for representing the star as it moves from the center portion of the plane display to the periphery portion, the star can be represented as if the star is moving on a curved surface when observed by a viewer. Also, with regard to the size of light spot representing a star in the vicinity of the viewer (i.e., in the vicinity of “the horizon” of the planetarium) and the size of light spot representing a star in the vicinity of vertex of the viewer (i.e., in the vicinity of zenith of the planetarium), it is preferred that the size in the zenith has an increased size, since otherwise, the star cannot be observed to have a constant size when observed by a viewer. According to the present invention, the size and density of pixels in the vicinity of the horizon and the size and density of pixels in the vicinity of zenith can be selected relatively freely, so that the size of the star can be kept visually constant when the light spot is observed by a viewer, regardless of the height. Such projection software can be made relatively simply.

While the display apparatus according to the present invention has been described above in great detail with reference to the preferred embodiments, it is needless to say that various changes may be made without departing from the scope of the invention as defined by the appended claims.

What is claimed is:

1. A display apparatus comprising plural display units, wherein each of the display units comprises a light guide plate for transmitting light therethrough, and a display element which is provided opposite to one plate surface of said light guide plate, said display element comprising a driving portion provided with actuator portions of a number corresponding to that of a number of pixels, said display element causing the light guide plate to display a video image according to an inputted image signal, by introducing light into the light guide plate and controlling displacement operations in contact and separation directions of the actuator portion with respect to the light guide plate according to properties of the image signal, and thereby controlling leakage light in a predetermined region of the light guide plate, and wherein the plural display units are joined and arranged so as to form a predetermined angle relative to each other.

2. A display apparatus according to claim 1, wherein the plural display units are joined so that the light guide plates of the display units, which are arranged adjacent to each other, form video image display surfaces that appear as if they are in one plane.

3. A display apparatus according to claim 1 or 2, wherein a joint angle of the display units is set to an angle at which a joint portion of said display units protrudes away from a viewer.

4. A display apparatus according to claim 1 or 2, wherein a joint angle of the display units is set to an angle at which a joint portion of said display units protrudes toward a viewer.

5. A display apparatus according to any one of claims 1-4, further comprising a reflector that is arranged along a side of the light guide plate in a joint portion of the display units.

6. A display apparatus according to claim 5, further comprising a light source that is arranged between the side of the light guide plate and the reflector.

7. A display apparatus according to any one of claims 1-6, further comprising a reflector that is arranged along that side of the light guide plate, which is remote from a joint portion of the display units.

8. A display apparatus according to claim 7, further comprising a light source that is arranged between said side of the light guide plate and the reflector.

9. A display apparatus according to any one of claims 1-8, further comprising a reflector that is arranged along top and/or bottom of the light guide plate.

10. A display apparatus according to claim 9, further comprising a light source that is arranged between the top and/or bottom of the light guide plate and the reflector at said top and/or bottom.

11. A display apparatus according to any one of claims 1-4 or 7-10, further comprising a columnar transparent body that is arranged along the side of the light guide plate in a joint portion of the display units, said columnar transparent body being out of contact with said side of the light guide plate.

12. A display apparatus according to claim 11, further comprising light absorption layers on upper and lower surfaces of the transparent body.

13. A display apparatus according to any one of claims 1-4, wherein the light guide plate is of a wedge-like sectional shape having a thickness that decreases gradually toward a joint portion of the display units.

14. A display apparatus according to claim 13, further comprising a reflector that is arranged on that side of the light guide plate, which is in the joint portion of the display units.

15. A display apparatus according to claim 13 or 14, further comprising a light source and a reflector both arranged along that side of the light guide plate, which is remote from the joint portion of the display units.

16. A display apparatus as in one of claims 13-15, further comprising a light source and a reflector both arranged along a top and/or a bottom of the light guide plate.

17. A display apparatus comprising a display unit, wherein the display unit comprises a light guide plate for transmitting light therethrough, and a display element which is provided opposite to one plate surface of said light guide plate, said display element comprising a driving portion provided with actuator portions of a number corresponding to that of a number of pixels, said display element causing the light guide plate to display a video image according to an inputted image signal, by introducing light into the light guide plate and controlling displacement operations in contact and separation directions of the actuator portion with respect to the light guide plate according to properties of the image signal, and thereby controlling leakage light in a predetermined region of the light guide plate, and wherein the light guide plate is formed as a curved surface having a predetermined curvature.

18. A display apparatus according to claim 17, further comprising a light source and/or a reflector, which is arranged along the side, the top and/or the bottom of the light guide plate.

19. A display system comprising plurality of display apparatuses according to any one of claims 1-18, wherein plurality of said display apparatuses are combined with each other to form a structural body having a desired three-dimensional shape.

20. A display system according to claim 9, wherein the light guide plates of the structural body having said three-dimensional shape are combined with each other to form a video image display plane on an inner surface of a planetarium.

21. A display apparatus comprising a display unit, wherein the display unit comprises a light guide plate for transmitting light therethrough, and a display element which is provided opposite to one plate surface of said light guide plate, said display element comprising a driving portion provided with actuator portions of a number corresponding to that of a number of pixels, said display element causing the light guide plate to display a video image according to an inputted image signal, by introducing light into the light guide plate and controlling displacement operations in contact and separation directions of the actuator portion with respect to the light guide plate according to properties of the image signal, and thereby controlling leakage light in a predetermined region of the light guide plate, and wherein the display unit is arranged to extend with a continuous band shape on a wall of a passage along which people traffic.

22. A display apparatus according to claim 21, further comprising a sensor for detecting traffic of people, said display apparatus being so arranged as to display a video image on the light guide plate, when the sensor detects traffic of people.

23. A display apparatus comprising a display unit, wherein the display unit comprises a light guide plate for transmitting light therethrough, and a display element which is provided opposite to one plate surface of said light guide plate, said display element comprising a driving portion provided with actuator portions of a number corresponding to that of a number of pixels, said display element causing the light guide plate to display a video image according to an inputted image signal, by introducing light into the light guide plate and controlling displacement operations in contact and separation directions of the actuator portion with respect to the light guide plate according to properties of the image signal, and thereby controlling leakage light in a predetermined region of the light guide plate, and wherein the light guide plate forms a video image display surface in a cinema complex.

24. A display apparatus comprising plural display units, wherein each of the display unit comprises a light guide plate for transmitting light therethrough, and a display element which is provided opposite to one plate surface of said light guide plate, said display element comprising a driving portion provided with actuator portions of a number corresponding to that of a number of pixels, said display element causing the light guide plate to display a video image according to an inputted image signal, by introducing light into the light guide plate and controlling displacement operations in contact and separation directions of the actuator portion with respect to the light guide plate according to properties of the image signal, and thereby controlling leakage light in a predetermined region of the light guide plate, and wherein the display element and the light guide plate have desired shapes, respectively, and the display apparatus has a desired shape by arranging the display element in close contact with a back side of the light guide plate with a desired configuration.

25. A display apparatus comprising plural display units, wherein each of the display unit comprises a light guide plate for transmitting light therethrough, and a display element which is provided opposite to one plate surface of said light guide plate, said display element comprising a driving portion provided with actuator portions of a number corresponding to that of a number of pixels, said display element causing the light guide plate to display a video image according to an inputted image signal, by introducing light into the light guide plate and controlling displacement operations in contact and separation directions of the actuator portion with respect to the light guide plate according to properties of the image signal, and thereby controlling leakage light in a predetermined region of the light guide plate, and wherein the display element is arranged in close contact with a desired position on a back side of the light guide plate, and at least one of a blank region, a light emission body, a scattering body and a light absorbing body is arranged at other desired position or positions on the back side of the light guide plate.

26. A display apparatus according to claim 25, wherein at least one of said light emission body, white scattering body and light absorbing body is arranged directly on a backside of the light guide plate.

27. A display apparatus according to claim 25, wherein at least one of said light emission body, white scattering body and light absorbing body is arranged on a back side of a light guide support made of a material having a refractive index close to that of the light guide plate which is a component of the display elements, and wherein said light guide support is arranged in tight contact with, or at a distance from a backside of the light guide plate.

28. A display apparatus according to claim 25, wherein said blank region is formed by a hollow region of the light guide plate.

29. A display apparatus according to claim 25, wherein the light guide support is arranged in the blank region, on a backside of the light guide plate.

30. A display apparatus comprising plural display units, wherein each of the display unit comprises a light guide plate for transmitting light therethrough, and a display element which is provided opposite to one plate surface of said light guide plate, said display element comprising a driving portion provided with actuator portions of a number corresponding to that of a number of pixels, said display element causing the light guide plate to display a video image according to an inputted image signal, by introducing light into the light guide plate and controlling displacement operations in contact and separation directions of the actuator portion with respect to the light guide plate according to properties of the image signal, and thereby controlling leakage light in a predetermined region of the light guide plate, and wherein said display elements include display elements having different color and/or different pixel area and/or different pixel pitch, and said display elements are arranged on a backside of the same light guide plate.

31. A display apparatus according to claim 30, wherein said display elements include display elements having a large pixel area that is black-and-white or monochromatic, forming a black-and-white or monochromatic high-brightness message display region, and display elements having a small pixel area of three primary colors, forming a high definition color image display region.

32. A display apparatus comprising plural display units, wherein each of the display unit comprises a light guide plate for transmitting light therethrough, and a display element which is provided opposite to one plate surface of said light guide plate, said display element comprising a driving portion provided with actuator portions of a number corresponding to that of a number of pixels, said display element causing the light guide plate to display a video image according to an inputted image signal, by introducing light into the light guide plate and controlling displacement operations in contact and separation directions of the actuator portion with respect to the light guide plate according to properties of the image signal, and thereby controlling leakage light in a predetermined region of the light guide plate, and wherein said display elements are arranged on backsides of the light guide plates, and the light guide plates are so arranged as to display portions of a video image from the same image signal source, respectively.
